(19) United States
(12) Patent Application Publication
(10) Pub. No.: US 2004/0229635 A1
(43) Pub. Date: Nov. 18, 2004

(54) Method for appending text to unused space left by the sender in a mobile text message

(75) Inventor: Matthew Hertz, Hasharon (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: OMBEK LTD

(21) Appl. No.: 10/436,048

(22) Filed: May 13, 2003

(51) Int. Cl. H04Q 7/20

(52) U.S. Cl. 455/466

(57) ABSTRACT

A method and system for appending text to unused space left by a sender when transmitting text message to a wireless device of a recipient. An attach appendix function preferably implemented in software provides an appendix that is attached to the text message in the unused space. The software determines the maximum length in characters allowed per-message to this recipient, and whether there is sufficient space remaining for an appendix. If sufficient space is available, the software retrieves a suitable appendix from a database of pre-defined messages and appends it to the original message. The original message along with the chosen appendix is then transmitted to the recipient.

### FIELD OF THE INVENTION

The present invention relates generally to methods for delivering messages to wireless devices such as cellular telephones and pagers and, more particularly, to a method for appending text to a message transmitted over wireless networks. A wireless networks may be for example a cellular, wireless telephone or paging network.

### BACKGROUND OF THE INVENTION

Mobile text messages (paging, and short-messaging-service and other methods referred to in this document as SMS) are text messages sent from or to mobile devices (such as mobile phones pagers, personal digital assistance (PDA) devices, etc.), and have pre-defined character limits depending on the type of network, mobile-device capabilities, and other factors. Users tend to write messages that are significantly shorter than the maximum allowed limits. Furthermore, when a message is sent across networks with different length limits, there may be a free space left by the end of the message.

SMS is a major source of revenue for wireless operators. Worldwide, more than one billion SMS messages are sent daily, generating significant revenues for operators, and providing a genuine service to wireless consumers. SMS is the fastest growing service in the wireless industry. As of late last year, the global explosion in SMS generated over one billion daily messages, translating into approximately $44 billion in added revenue for wireless carriers.

Systems that transmits messages between wireless devices or systems are known. FIG. 1 shows a basic configuration of an existing message transmission system 100. The system is a computer-based system, that includes a message “receive” function 102 and a message transmit or “send” function 104. Such a system is generally referred to as Short Messaging Service Center (SMSC), or SMSC-Gateway. In addition, there are systems outside the wireless network that generate a message and forward it to the SMSC for transmission, e.g External Short Message Entity (ESME). SMSC-Gateway is an SMSC with “receive” and “send” functions very much similar to a normal SMSC, but which transmits messages between different SMSCs. Both SMSC and SMSC-Gateway systems are developed for example by LogicaCMG (Stephenson House, 75 Hampstead Road London, NW1 2PL, UK). Receive function 102 receives messages from other wireless devices or other message-originating applications. These messages are transferred to transmit function 104, which transmits and monitors the transmitted messages. The receive function handles, among others, the acquisition of any new message from the network into the system, checks its details for data-integrity and other factors, then determines the protocol and subscriber to which it will be sent. Among the protocol and subscriber details is the maximum character allowed per message. When the receive function finishes the handling described above, the receive function triggers the send function and passes, among others, the information gathered above, to the send function. In turn, the send function sends the message over the network using the protocol and subscriber details.

Attempts to use the popular SMS medium to send messages containing advertisements and promotions are met with two great challenges. The first is the natural resistance from the recipient consumers to the nuisance of getting non-solicited messages, and the second is the tendency to discard a non-solicited message without reading its content. The ability to tap into the “space” at the end of every message represents a solution to both challenges, as promoters may get their message across without annoying consumers with unsolicited messages. In addition, consumers are more likely to read messages that appear as appendix to a genuinely important message.

In prior art, U.S. Pat. No. 6,381,465 to Cherns, which is incorporated herein in its entirety by reference, discloses a monitoring and alert system that includes a requesting device with a transmitter for sending a monitoring request and a receiver for receiving an alert message over a wireless telecommunications network. The requesting device may be a wireless communications handset or a personal computer. A “wireless handset” refers to any communication device capable of communicating with other devices via a wireless networks. The request is sent to a remote server, which evaluates it, and generates both an alert message and an appended ad message in the remaining message space. This composite alert/ad message is then sent by the remote server to the requesting device. Thus, the source of both the original and the appended messages is the same, so it only applies to users of, and messages sent from, the above alert server. This system does not offer solution for tapping into a text message with unused space sent by any other source to a recipient, to which a system separate from the originating system or device could independently add a matching appendix tailored to the recipient.

There is therefore a need for, and it would be advantageous to have, a method and system for appending text to the space left by the end of an SMS message already sent to the mobile recipient.

### SUMMARY OF THE INVENTION

The present invention provides a system and method for appending text to the space left by the end of an SMS message already sent to the mobile recipient over a wireless network.

According to the present invention there is provided a computer-implemented method for appending text to an original SMS message of a given message length comprising the steps of determining essential appendix attachment information; based on the appendix attachment information, attaching an appendix to the original SMS message to form an appendix added message; and transmitting the appendix added message to a message recipient.

According to one feature in the method of the present invention, the step of determining essential appendix attachment information includes determining recipient data and appendix data.

According to another feature in the method of the present invention, the determining of recipient data includes accessing and retrieving data stored in a recipient profile database, and wherein the determining of appendix data includes accessing and retrieving data stored in an available appendix database that includes pre-defined appendices.

According to yet another feature in the method of the present invention, the accessing and retrieving of data stored in a recipient profile database includes accessing and retrieving data selected from the group consisting of recipient identification (ID), IDs of past appendices sent to the recipient, locality of the recipient, and time zone of the locality.

According to yet another feature in the method of the present invention, accessing and retrieving of data stored in an available appendix database includes accessing and retrieving data selected from the group consisting of appendix ID, content of each appendix, appendix length, relevant location for a particular appendix, relevant daytime, and validity dates.

According to yet another feature in the method of the present invention, the step of determining essential appendix attachment information further includes determining the length of the original message, receiving a maximum length in characters allowed, determining an available space for appending text from the original message length and the maximum allowed length, and, based on the recipient data and the appendix data, finding a matching appendix that matches the available space.

According to another feature in the method of the present invention, the step of attaching an appendix includes attaching the matching appendix.

According to the present invention, the method further comprises updating the recipient profile database that the appendix added message has been sent to the recipient.

According to the present invention there is provided a system used for appending text to a SMS message sent to a recipient, comprising a message receive function for receiving an original SMS message of a given length; a message transmit function for transmitting a SMS message that includes an attached appendix having an appendix length correlated with the original message length; and an attach appendix function configured to communicate with the receive function and with databases, and used to provide the attached appendix.

According to one feature in the system of the present invention, the attach appendix function is operative to access and retrieve recipient data related to the recipient from one of the databases, the attach appendix function further operative to access and retrieve data related to the attached appendix.

According to another feature in the system of the present invention, the attach appendix function includes a software component for effecting the communication with the receive function and the databases and for providing the attached appendix.

According to yet another feature in the system of the present invention, the databases are internal to the system.

According to yet another feature in the system of the present invention, the databases are external to the system, and the attach appendix function includes communication means to communicate with the external databases.

### BRIEF DESCRIPTION OF THE DRAWINGS

The invention is herein described, by way of example only, with reference to the accompanying drawings. In the drawings, like reference numbers indicate identical or functionally similar elements.

FIG. 1 shows a basic configuration of an existing message transmission system;

FIG. 2 shows a preferred embodiment of a message transmission system according to the present invention;

FIG. 3 is a flowchart showing the process of the message attachment function according to the present invention;

FIG. 4 shows an exemplary table in a recipient profile database according to the present invention;

FIG. 5 shows an exemplary table in an available appendix database according to the present invention;

FIG. 6 shows examples of text messages with or without appended ad messages on wireless handset displays;

### DETAILED DESCRIPTION OF PREFERRED EMBODIMENTS

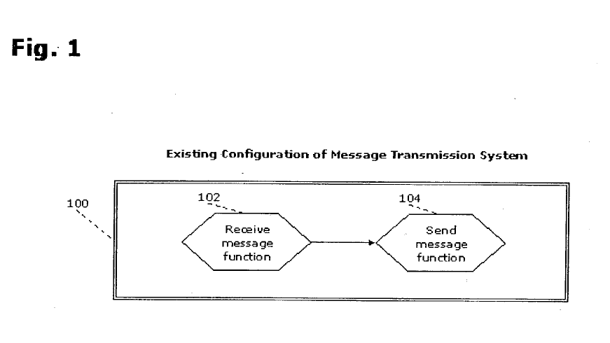

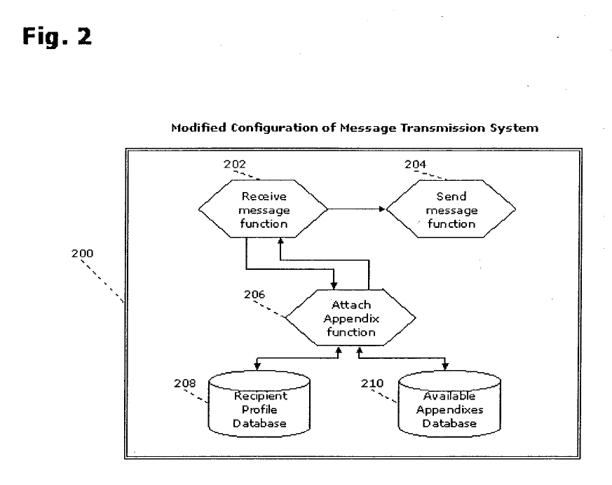

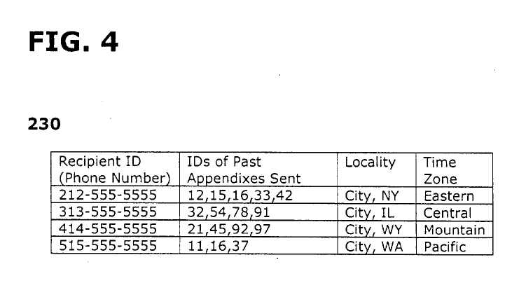

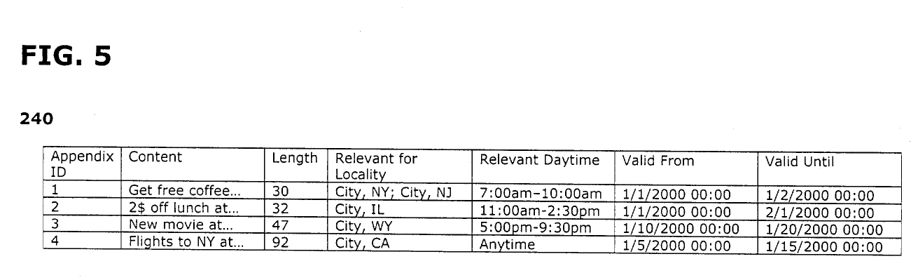

The present invention provides a method and system for appending text to unused space left by a sender when transmitting a text message to wireless devices. The combined original text and appended text are referred to as appendix added message. The method is preferably implemented by a computer-based system 200 shown in FIG. 2. System 200 may be similar to system 100 of FIG. 1, in that it comprises both a message receive function 202 and a transmit function 204, but is not limited to the architecture of system 100. That is, any message transmission system in which SMS messages having unused space are received and transmitted, and in which the unused space can be additionally “treated”, i.e. addressed, manipulated and otherwise changed, falls within the scope of the present invention. Unlike system 100, system 200 further comprises an attach appendix function 206 configured to communicate with receive function 202 and with databases, for example a recipient profile database 208, and an available appendix database 210. The attach appendix function uses essential message information and these databases to determine essential appendix attachment information, described below. Databases 208 and 210 may be an integral part of (i.e. internal to) system 200, or may be external to system 200, in which case system 200 includes communication means that connect the attach appendix function to each database. The communication means may include radio-frequency, wired networks, fiber optic communications or light channels, and other media. Recipient profile database 208 includes a look-up table 230 that includes recipient data, for example recipient ID in the form of a full phone number, IDs of past appendices sent to each recipient, the locality of the recipient, and the time zone of the locality. An exemplary table 230 is shown in FIG. 4. In the table, as an example, a recipient identified by phone number 212-555-5555 is shown to have received in the past appendices identified by numbers 12, 15, 16, 33 and 42. The location of this recipient is “City, N.Y.” and his time zone is “Eastern”. Other recipients are similarly fully identified. Available appendix database 210 includes data such as appendix ID, content of each appendix, appendix length, relevant location for a particular appendix, relevant daytime, and validity dates. Such data, in the form of a table 240 is shown in FIG. 5. FIG. 5 shows for example an appendix “1” with a content “Get free coffee . . . ” that has a length of 30 characters. Appendix 1 is relevant for two localities: City, N.Y. and City, N.J. The relevant daytime for its transmission is between 7:00 and 10:00 am, and its validity dates are between 00:00 hours, Jan. 1, 2000 and 00:00 hours Jan. 2, 2000. An exemplary database system that may be used either for database 208 or database 210 (or both) is an Oracle database (Oracle Corp., Redwood Shores, Calif.). The retrieval of data from the database is done by standard database tools for query and update, which are well known as “Structured Query Language” (SQL). One example of a book describing SQL is “SQL: A Beginner's Guide” by Forrest Houlette, McGraw-Hill, 2000.

Attach appendix function 206 preferably includes a software component (or simply “software”) 212, used to perform a number of steps in the method described below. These steps reflect the treatment or “address, manipulation and otherwise change of unused space” mentioned above.

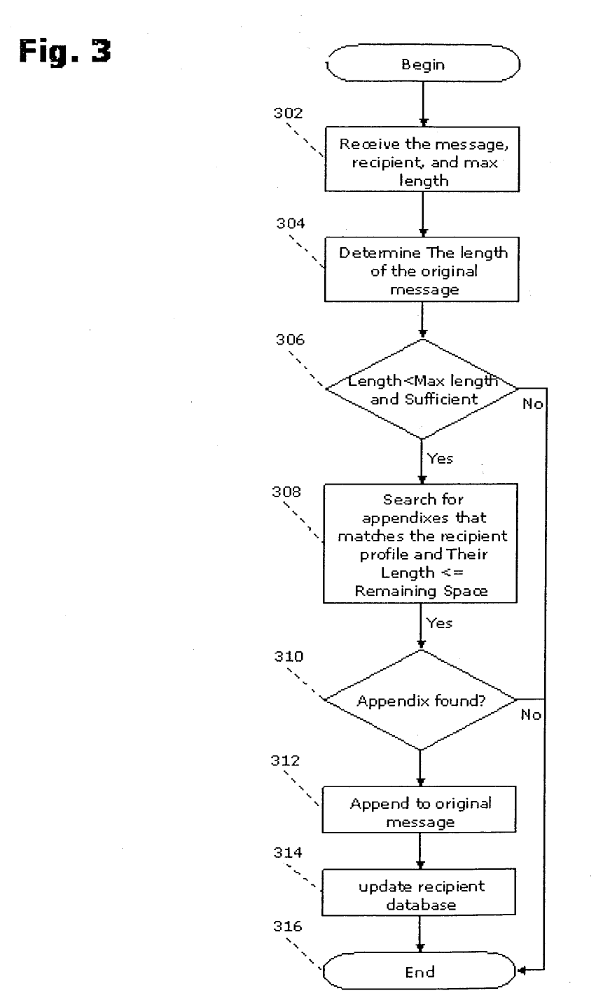

In use, in contrast with methods used in prior art systems, a message received by the receive function undergoes the additional treatment prior to being sent to the send function. The additional treatment, which embodies the essential features of the method of the present invention, and which involves exchange of information with databases, is performed by attach software 212, and is described in detail in FIG. 3.

In FIG. 3, attach function 206 (through software 212) receives from receive function 202 essential message information such as message content, recipient ID (e.g. 10 digits telephone number), and maximum allowed length in characters in step 302. In other words, function 206 determines recipient data by accessing and retrieving data stored in the recipient profile database. Receive function 202 is configured to trigger attach appendix function 206 before it triggers send function 204. Receive function 202 is also configured to pass to the attach appendix function the recipient address, the maximum allowed characters and the content of the message. Function 206 determines the length of the original message in step 304, and further determines an available (unused) space by comparing the length in characters of the transmitted message with the maximum length in step 306. Function 206 then determines whether the unused space is sufficient for an appendix in step 308. If the unused space is sufficient (i.e. it has a minimal length in space to allow attachment, say 20 characters or other pre-defined minimum), function 206 looks for a pre-defined matching appendix in available appendix database 210 that matches the unused space and the recipient profile in step 310. This step is done preferably in the following fashion: function 206 looks up the recipient profile, and collects the recipient data from table 230 in database 208. The function uses this data to search for matching records in the available appendixes database 210. In other words, function 206 determines appendix data by accessing and retrieving data stored in the available appendix database, which includes pre-defined appendices.

For example, if the recipient's locality is City, ST, the function looks for the corresponding locality in database 210 so that only promotions relevant for that City, ST, will appear in the results. In the same manner, the function looks only for appendices that were not already sent to the user, so as to avoid resending the same message over and over again. Function 206 then determines if such appendix was found in step 312. If yes, function 206 appends the found pre-defined appendix to the original message in step 314, and updates the recipient profile database that this appendix was already used in step 316. If not, the procedure ends. After the attachment of the appendix is over, the full (appendix added) message is transmitted to the recipient by the message transmission system.

As shown in FIG. 3, at any decision point in the process, a negative result will cause the attach appendix function to end. When the attach appendix function ends, it triggers the receive function to move forward and trigger the send function using the new appended content.

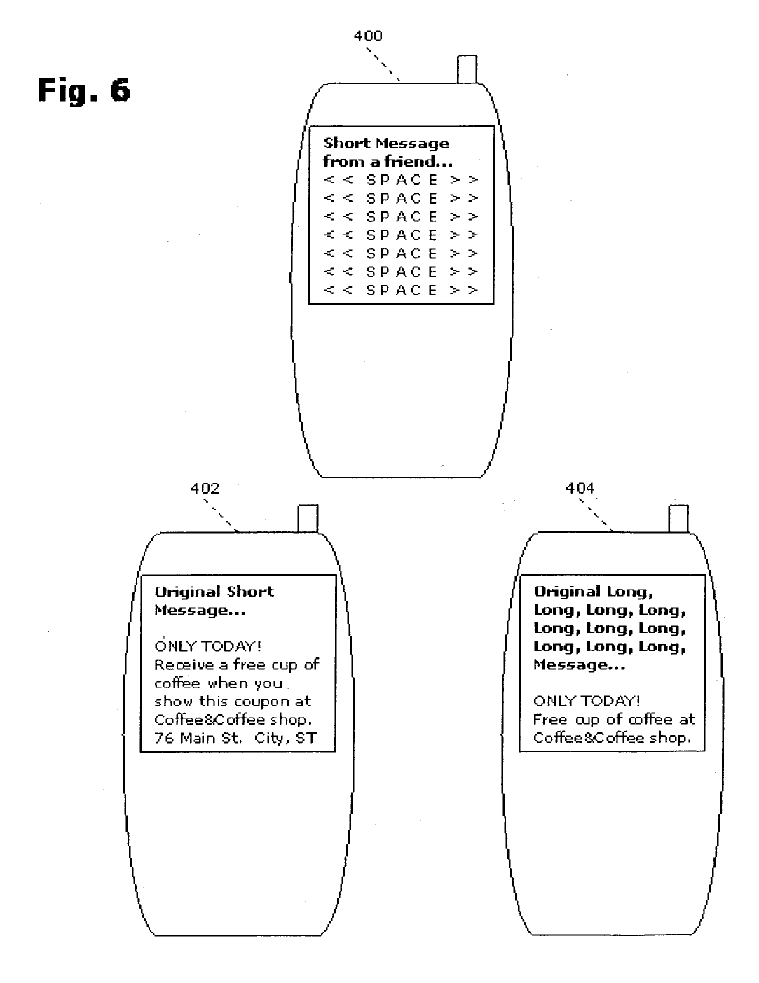

FIG. 6 shows examples of text messages with or without appended ad messages on wireless handset displays. A wireless handset display 400 shows an exemplary existing situation in which the message originator has sent a message that is shorter than the maximum characters allowed (in this example only 30 characters out of the 160 allowed), leaving 130 characters of available empty space marked as <<space>>. Wireless handset displays 402 and 404 show two examples of attached appendices to an existing message according to the present invention. In these items, the SMSC is configured to append promotions to the unused space. Consequently, the “attach appendix” function has determined that the messages in displays 402 (only 25 characters long, 135 characters available) and 404 (only 79 characters long, 81 characters available) are each suited to a respective appendix, and has appended the respective appendix to the original message content. Also illustrated in this example is the fact that display 402 has a longer appendix (112 characters) than display 404 (53 characters), so that the attached appendices always equals or is less than the remaining space.

The system described above can be implemented in software or hardware, or a combination of software and hardware. When implemented primarily in hardware, it may using components such as Programmable Array Logic units (PALs), application specific integrated circuits (ASICs), or other hardware components. Implementation of a hardware state machine to perforin the functions described herein will be apparent to persons skilled in the relevant art(s).

All publications and patents mentioned in this specification are herein incorporated in their entirety by reference into the specification, to the same extent as if each individual publication or patent was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. What has been described above is merely illustrative of the application of the principles of the present invention. Those skilled in the art can implement other arrangements and methods without departing from the spirit and scope of the present invention. The method of the invention can be implemented in software, which can be stored on computer disks or other computer-readable media, for execution in a host or target computer. In addition, citation or identification of any reference in this application shall not be construed as an admission that such reference is available as prior art to the present invention.

What is claimed is:

1. A computer-implemented method for appending text to an original SMS message of a given message length comprising the steps of:
a) determining essential appendix attachment information;
b) based on said appendix attachment information, attaching an appendix to the original SMS message to form an appendix added message; and
c) transmitting said appendix added message to a message recipient.

2. The method of claim 1, wherein said step of determining essential appendix attachment information includes determining recipient data and appendix data.

3. The method of claim 2, wherein said determining of recipient data-includes accessing and retrieving data stored in a recipient profile database, and wherein said determining of appendix data includes accessing and retrieving data stored in an available appendix database that includes pre-defined appendices.

4. The method of claim 3, wherein said accessing and retrieving data stored in a recipient profile database includes accessing and retrieving data selected from the group consisting of recipient ID, IDs of past appendices sent to said recipient, locality of said recipient, and time zone of said locality.

5. The method of claim 3, wherein said accessing and retrieving data stored in an available appendix database includes accessing and retrieving data selected from the group consisting of appendix 1D, content of each appendix, appendix length, relevant location for a particular appendix, relevant daytime, and validity dates.

6. The method of claim 2, wherein said step of determining essential appendix attachment information further includes
i. determining the length of the original message;
ii. receiving a maximum length in characters allowed;
iii. determining an available space for appending text from said original message length and said maximum allowed length; and
iv. based on said recipient data and said appendix data, finding a matching appendix that matches said available space.

7. The method of claim 6, wherein said step of attaching an appendix includes attaching said matching appendix.

8. The method of claim 3, further comprising updating said recipient profile database that said appendix added message has been sent to said recipient.

9. A system used for appending text to a SMS message sent to a recipient, comprising:
a. a message receive function for receiving an original SMS message of a given length;
b. a message transmit function for transmitting a SMS message that includes an attached appendix having an appendix length correlated with said original message length; and
c. an attach appendix function configured to communicate with said receive function and with databases, and used to provide said attached appendix.

10. The system of claim 9, wherein said attach appendix function is operative to access and retrieve recipient data related to the recipient from one of said databases, said attach appendix function being further operative to access and retrieve data related to said attached appendix.

11. The system of claim 9, wherein said attach appendix function includes a software component for effecting said communication and said provision.

12. The system of claim 9, wherein said databases are internal to the system.

13. The system of claim 9, wherein said databases are external to the system, and wherein said attach appendix function includes communication means to communicate with said external databases.
